(19) United States
(12) Patent Application Publication
(10) Pub. No.: US 2024/0118297 A1
(43) Pub. Date: Apr. 11, 2024

(54) AUTOMATED BIOPSY SAMPLE PROCESSING SYSTEMS AND METHODS THEREOF

(71) Applicant: BiopTek, Inc., Fulshear, TX (US)

(72) Inventors: Nanetta Rapuano, League City, TX (US); Michael Peter Mikulasovich, Fulshear, TX (US)

(21) Appl. No.: 18/542,235

(22) Filed: Dec. 15, 2023

Related U.S. Application Data
(63) Continuation of application No. PCT/US22/34018, filed on Jun. 17, 2022.
(60) Provisional application No. 63/212,232, filed on Jun. 18, 2021.

(51) Int. Cl. G01N 35/00; G01N 35/04

(52) U.S. Cl. CPC G01N 35/00732; G01N 35/04; G01N 2035/00752; G01N 2035/00772; G01N 2035/00831; G01N 35/0099; G01N 2035/0405

(57) ABSTRACT

Automated systems for processing a biopsy sample are disclosed herein, as well as methods for automating the processing of a biopsy sample. A benefit to the automated systems and methods herein can be the efficient and cost-effective processing of large numbers of biopsy samples. Another benefit to the automated systems and methods herein can be increased personnel safety for processing biopsy samples. Additional benefits to the automated systems and methods herein can be greater patient safety by increasing accuracy in biopsy sample processing, and preventing errors in biopsy sample processing that may lead to misdiagnosis and improper treatments.

### CROSS REFERENCE TO RELATED APPLICATIONS

This application claims priority to International Patent Application No. PCT/US2022/034018, filed on Jun. 18, 2022, entitled “AUTOMATED BIOPSY SAMPLE PROCESSING SYSTEMS AND METHODS THEREOF” which claims priority to U.S. Provisional Patent Application Ser. No. 63/212,232, filed on Jun. 18, 2021 entitled “AUTOMATED BIOPSY SAMPLE PROCESSING SYSTEMS AND METHODS THEREOF” which is hereby expressly incorporated by reference in their entireties for all purposes.

### TECHNICAL FIELD

Automated systems for processing a biopsy sample are disclosed herein, as well as methods for automating the processing of a biopsy sample. A benefit to the automated systems and methods herein can be the efficient and cost-effective processing of large numbers of biopsy samples. Another benefit to the automated systems and methods herein can be increased personnel safety for processing biopsy samples. Additional benefits to the automated systems and methods herein can be greater patient safety by increasing accuracy in biopsy sample processing and preventing errors in biopsy sample processing that may lead to misdiagnosis and improper treatments.

### BACKGROUND

The processing of tissue biopsy samples is commonly performed during the course of medical diagnosis and treatment. Standardized procedures are used to process virtually all types of biopsy samples, including the laboratory methods that are used to prepare the samples for analysis. These procedures are subject to recognized industry standards and government regulation. After collection, biopsy samples are routinely placed into a labeled container with a mixture of water and formaldehyde. A bulk examination may be performed on the samples before further processing, which may include taking a photograph of the sample as part of recording the tissue specimen's characteristics that can be observed without the use of a microscope. The samples are further processed by transferring the tissue specimens in the biopsy samples from the labeled sample containers into identically labeled cassettes. These procedures involve the input of many time consuming and repetitive manual steps that must be carried out by a trained professional. Most pathology laboratories process hundreds of biopsy samples on a daily basis. There remains a need for systems and methods that can perform the standardized processing of biopsy samples in an efficient and cost-effective manner, while meeting industry and regulatory requirements for such processing.

### SUMMARY

Embodiments herein are directed to an automated system for processing a biopsy sample. In various embodiments, the automated system includes: a container mechanical manipulator configured to transfer a biopsy sample from a labeled sample container to an empty sample cassette; a sample container lid removal mechanism configured to remove a lid from the sample container before transfer of the biopsy sample to the empty sample cassette; a cassette mechanical manipulator configured to convert the empty sample cassette from a closed to an open cassette position, to receive the transfer of the biopsy sample from the sample container by filtration, and to return the sample cassette to the closed cassette position after transfer of the biopsy sample to form a filled sample cassette; a scanning optical reader configured to read label information from the labeled sample container and to transfer the sample container label information to a central processing unit (CPU), and a computer database configured to store the label information; and a formalin repository containing a volume of formalin solution and configured to receive the filled sample cassette.

In certain embodiments, the automated system includes a cassette labeler, wherein the cassette labeler is configured to receive the sample container label information from the computer database and to label the empty sample cassette with cassette label information to form an empty labeled sample cassette, or to label the filled sample cassette to form a filled labeled sample cassette.

In various embodiments, the sample container label information includes a patient name, a patient date of birth, a sample record number, a sample collection date, a sample collection location, a sample bar code, a sample quick response code (QR code), or a combination thereof. In certain embodiments, the cassette label information includes a unique alphanumeric sequence, a cassette bar code, or a cassette QR code.

In certain embodiments, the automated system further includes a sample conveyor configured to convey the labeled sample container containing a biopsy sample to the container mechanical manipulator. In certain embodiments, the sample conveyor comprises at least one of a conveyor belt, a ramp, or a slide.

In certain embodiments, the container mechanical manipulator or the cassette mechanical manipulator includes a robotic arm capable of at least one of translational motion and at least one rotational motion. In certain embodiments, the container mechanical manipulator comprises a clamp mechanism configured to hold or grip the sample container in a controlled or fixed position. In certain embodiments, the container mechanical manipulator includes the sample container lid removal mechanism. In certain embodiments, the sample container lid removal mechanism includes a lid mechanical manipulator. In certain embodiments, the sample container lid includes a screw-on lid or a snap-on lid.

In certain embodiments, the automated system further includes a sample container rinsing mechanism and a sample container disposal repository, wherein the container mechanical manipulator is configured to position at least one of the labeled sample container, the empty sample cassette, and the filled sample cassette under the sample container rinsing mechanism before, during, or after transfer of the biopsy sample to the empty sample cassette. In some embodiments, the sample container rinsing mechanism includes a storage mechanical manipulator configured to transfer the sample container to the sample container disposal repository after rinsing the sample container with a volume of a rinsing solution. In such embodiments, the rinsing solution includes water, formaldehyde, formalin, or a combination thereof.

In certain embodiments, the container mechanical manipulator and the cassette mechanical manipulator are the same or different. In certain embodiments, the cassette mechanical manipulator and the storage mechanical manipulator are the same or different.

In certain embodiments, the scanning optical reader includes a bar code reader, a camera, a portable image capture device, such as a tablet, or camera. Some embodiments of the automated system further include a sample camera connected to the CPU, and configured to generate a photographic image of the labeled sample container, the labeled sample cassette, the biopsy sample, the filled labeled sample cassette, or a combination thereof; and to store the photographic image in the computer database

In certain embodiments, the sample cassette includes a filter, wherein the filter includes a mesh material; in certain embodiments, the mesh material includes a mesh bag.

In certain embodiments, the biopsy sample includes at least one biopsy tissue specimen. In some embodiments, the biopsy sample optionally includes a volume of formalin. In certain embodiments, the at least one biopsy tissue specimen has a diameter of from about 0.5 mm to about 5 mm. In certain embodiments, the volume of formalin comprises about 10% formaldehyde and about 90% water. In certain embodiments, the biopsy sample has a volume of from about 10 ml to about 15 ml.

Certain embodiments of an automated system further include a cassette conveyor, wherein the cassette conveyor includes a slide, a ramp, or a conveyor belt. In certain embodiments, the cassette conveyor belt is configured to convey empty labeled cassettes from the cassette labeler to at least one of the container mechanical manipulator or the cassette mechanical manipulator.

In certain embodiments, the automated system further includes a pre-scanning mechanism configured to scan the biopsy sample in the sample container to detect a sample error. In certain embodiments, the automated system further includes a scanning mechanism to detect a sample error in the filled sample cassette.

In certain embodiments, the automated system further includes an alarm configured to sound when the pre-scanning mechanism or the scanning mechanism detects a sample error. In certain embodiments, the sample error includes the presence of a foreign object in the biopsy sample, the presence of a biopsy tissue specimen having a diameter larger than about 5 mm in the biopsy sample, a biopsy tissue specimen remaining in the sample container after transfer of the biopsy sample to the sample cassette, or a combination thereof. In certain embodiments, the system is configured to halt biopsy sample processing upon detection of a sample error.

Embodiments of a method for automating the processing of a biopsy sample are disclosed herein. In various embodiments, the method includes: providing a labeled sample container, wherein the labeled sample container comprises a lid and a vessel, wherein the labeled sample container is sealed, and wherein the labeled sample container contains a biopsy sample in a volume of formalin; transmitting sample container label information from the labeled sample container to a CPU and a computer database by scanning the labeled sample container with a scanning optical reader; fixing a position of the labeled sample container by gripping an exterior of the vessel with a container mechanical manipulator; converting the labeled sample container into an open labeled sample container by clamping the lid with a sample container lid removal mechanism and rotating the lid in a clockwise or counterclockwise direction and/or applying force to the lid in a direction away from the vessel; forming a filled open sample cassette by rotating the container mechanical manipulator until the biopsy sample pours or falls onto a top surface of an open sample cassette; and converting the filled open sample cassette into a filled closed sample cassette by applying pressure to an exterior of the filled open sample cassette with a cassette mechanical manipulator.

Certain embodiments further include placing the filled closed sample cassette into a formalin repository containing a volume of formalin solution.

In certain embodiments, the method further includes labeling the open sample cassette by conveying the open sample cassette to a cassette labeler. In certain embodiments, the method further includes labeling a closed sample cassette by conveying the closed sample cassette to a cassette labeler.

In certain embodiments, the method further includes transmitting a cassette label information from the CPU and the computer database to the cassette labeler. Certain embodiments include printing a unique alphanumerical sequence, a cassette bar code, or a cassette QR code onto a cassette label, wherein the unique alphanumerical sequence, the cassette bar code, or the cassette QR code correspond to the sample container label information. In certain embodiments, the method further includes creating a photographic image of at least one of the labeled sample container or the filled closed sample cassette; and saving the photographic image to the CPU and the computer database.

In certain embodiments, the method further includes washing the biopsy sample on the open sample cassette, the open labeled sample container, or both with a washing volume from a sample container rinsing mechanism. In various embodiments, the washing volume includes water, formaldehyde, formalin, or a combination thereof.

In certain embodiments, the method for automating the processing of a biopsy sample further includes: before, during, or after the step of transmitting sample container label information from the labeled sample container to a CPU and a computer database, determining at least one characteristic of the biopsy sample by imaging the biopsy sample through a transparent wall of the labeled sample container, through a transparent wall of the open labeled sample container, or through an opening of the open labeled sample container with a measuring optical reader, or within the open sample cassette wherein the at least one characteristic of the biopsy sample includes at least one of a color of a biopsy tissue, a number of pieces of the biopsy sample, and a size of the pieces of the biopsy sample; and recording the at least one characteristic in the computer database; and optionally, wherein the scanning optical reader and the measuring optical reader are the same or different.

### BRIEF DESCRIPTION OF THE DRAWINGS

FIG. 1A shows a schematic view of an automated system according to embodiments herein.

FIG. 1B shows a schematic depiction of a magnified view of FIG. 1A.

FIG. 1C shows a schematic depiction of a magnified view of FIG. 1A.

FIG. 1D shows a schematic depiction of a magnified view of FIG. 1A.

FIG. 1E shows a schematic depiction of a magnified view of FIG. 1A.

FIG. 2A shows a schematic view of an automated system according to embodiments herein.

FIG. 2B shows a schematic depiction of a magnified view of FIG. 2A.

FIG. 2C shows a schematic depiction of a magnified view of FIG. 2A.

FIG. 2D shows a schematic depiction of a magnified view of FIG. 2A.

FIG. 2E shows a schematic depiction of a magnified view of FIG. 2A.

FIG. 3 shows an illustration of a method of processing a biopsy sample, according to embodiments herein.

FIG. 4 shows a schematic view of an automated system according to embodiments herein.

FIG. 5 shows a top-down angle of the automated system of FIG. 4.

FIG. 6 shows a side profile angle of the automated system of FIG. 4.

FIG. 7 shows a close-up view of the automated system of FIG. 4, during operation, when a robotic arm removes a sample vial from a conveyor belt.

FIG. 8 shows a close-up view of the automated system of FIG. 4, during operation, when the robotic arm positions the sample vial on a rotary wheel during a label scanning step.

FIG. 9 shows a close-up view of the automated system of FIG. 4, during operation, when the robotic arm positions the sample vial for label printing.

FIG. 10 shows a close-up view of the automated system of FIG. 4, during operation, when the robotic arm inserts the sample vial into a top remover to remove the top from the sample vial.

FIG. 11 shows a close-up view of the automated system of FIG. 4, during operation, when the robotic arm tilts the sample vial downward such that the contents are washed out onto an open cassette.

FIG. 12 shows a close-up view of the automated system of FIG. 4, during operation, when the cassette printer prints a label onto a closed cassette.

FIG. 13 shows a close-up view of the automated system of FIG. 4, during operation, when the cassette opener opens a closed cassette.

FIG. 14 shows a close-up view of the automated system of FIG. 4, during operation, when the high-resolution camera scans the open cassette.

FIG. 15 shows a close-up view of the automated system of FIG. 4, during operation, when the cassette closer closes an open cassette.

FIG. 16 shows a close-up view of the automated system of FIG. 4, during operation, when the rotary table slides the closed cassette into a cassette bin.

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. Unless otherwise noted, the drawings are not to scale.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of a color of a biopsy tissue, a number of pieces of the biopsy sample, and a size of the pieces of the biopsy sample” means a color of a biopsy tissue, a number of pieces of the biopsy sample, a size of the pieces of the biopsy sample, or any combination thereof.

Unless otherwise noted, the term “about” refers to ±10% of the non-percentage number that is described, rounded to the nearest whole integer. For example, about 10 ml, would include 9 to 11 ml. Unless otherwise noted, the term “about” refers to ±5% of a percentage number. For example, about 10% would include 5 to 15%. When the term “about” is discussed in terms of a range, then the term refers to the appropriate amount less than the lower limit and more than the upper limit. For example, from about 0.5 mm to about 5 mm would include from 0.45 to 5.5 mm.

Unless otherwise noted, properties (height, width, length, ratio etc.) as described herein are understood to be averaged measurements.

Unless otherwise noted, the terms “provide”, “provided” or “providing” refer to the supply, production, purchase, manufacture, assembly, formation, selection, configuration, conversion, introduction, addition, or incorporation of any element, amount, component, reagent, quantity, measurement, or analysis of any method or system of any embodiment herein.

Every business day, hundreds of tissue biopsy samples are routinely collected from patients as part of receiving medical treatment and diagnosis. These samples are often collected from remote care facilities and sent off-site to specialized pathology laboratories. Other times they are sent from a large hospital complex to a specialized pathology laboratory within the complex. Biopsy samples of various types are processed for analysis using a set of regulated procedures designed to provide for the uniform preparation of specimens suitable for a successful pathological evaluation. Pathology laboratories use the same standardized procedures to process virtually all types of biopsy samples. Directly or soon after collection, biopsy samples are routinely placed into a labeled sample bottle containing a fixative, which is usually formalin, a mixture of water and formaldehyde. The sample bottles are labeled with the pertinent patient and sample information, and transferred to a pathology laboratory for further processing.

At the pathology lab, a bulk examination may be performed on the biopsy samples before further processing, which may include taking a photograph of the sample as part of recording the tissue specimen's characteristics that can be observed without the use of a microscope. This step can ensure that the sample is of a high quality sample and free of foreign objects before passing the sample on for subsequent pathological evaluation, and in turn an accurate diagnosis and prognosis. The tissue specimens in the sample must be within the required size and thickness dimensions for processing, neither too large nor too small. Appropriate corrective action by laboratory personnel may be necessary before processing a sample, if any tissue specimen portions of the biopsy sample are outside of the prescribed parameters.

The biopsy samples are further processed by transferring the tissue specimens in the biopsy samples from the labeled sample containers into identically labeled cassettes. A strict adherence to the regulatory approved standardized procedures for processing the samples is key, because pathologists, doctors, or other medical personnel must rely on the quality of the processed samples to make an accurate diagnosis. An important dimension to biopsy sample processing is the need for strictly accurate correspondence between the labeling information on a sample biopsy container that arrives at the lab, and the label information on the corresponding sample cassette that the biopsy sample is transferred into from the sample container. The sample container label information is commonly entered into a computer database, which may be done manually or by the use of a bar code on the sample container that is read by a bar code reader. The label information is then transferred to a cassette labeler that places the label information corresponding to the sample container label onto a sample cassette. The technician must remove the lid from the sample container and transfer the sample, including the biopsy tissue specimens and the formalin, through a filter into the correctly labeled sample cassette. The sample cassette must be opened for filtering and transfer of the biopsy sample, then closed and placed into a repository containing formalin. The empty sample container is rinsed, then placed in a disposal container. These steps require the handling of formaldehyde containing solutions, presenting a personnel safety concern as formaldehyde is a hazardous chemical.

All of these procedures involve the input of many time consuming and repetitive manual steps that must be carried out by professionals having a great deal of specialized training. Most pathology laboratories process hundreds of biopsy samples on a daily basis. The need to process so many samples daily can put a strain on the technicians to meet the demand, while maintaining the high degree of accuracy required and adhering to standardized procedures. Following the required procedures manually can not only increase the risk for errors even with highly trained professionals, but requires a very large amount of time. A way to alleviate or eliminate the amount of manual input required by a technician, while allowing adherence to the standardized procedures, could result in not only greater accuracy, but more efficient, safer, and cost-effective processing of biopsy samples. There remains a need for systems and methods that can perform the standardized processing of biopsy samples in an efficient, safe, and cost effective manner, while meeting regulatory standards for such processing.

### Automated Systems of Various Embodiments

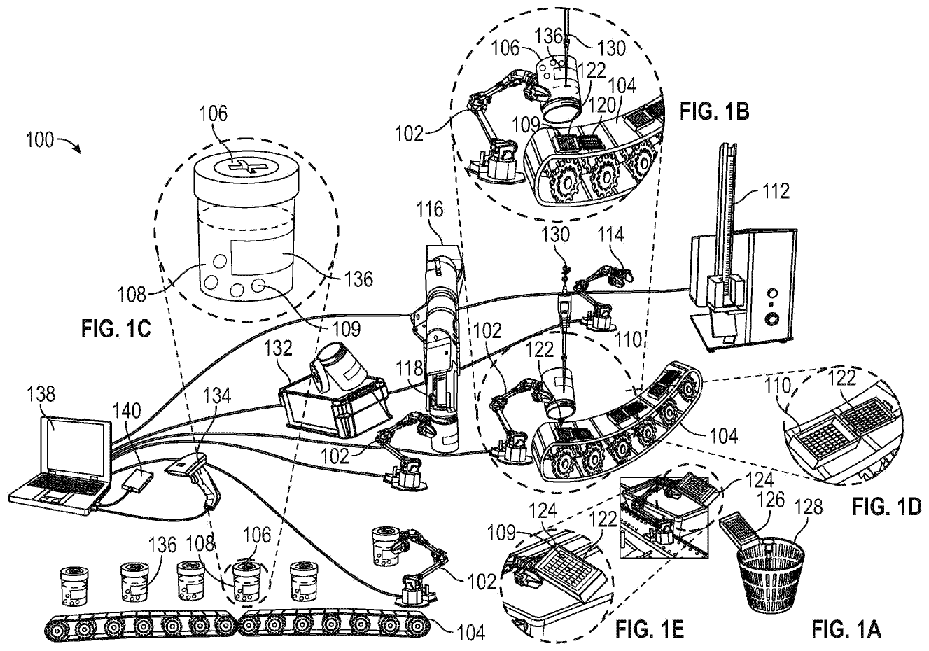

Embodiments of automated systems for processing a biopsy sample are disclosed herein. In an embodiment, referring to FIG. 1, automated system 100 includes a container mechanical manipulator 102 and a conveyor belt sample conveyor 104 configured to convey labeled sample container 106 containing biopsy sample 108, including at least one biopsy tissue specimen 109, to container mechanical manipulator 102. Labeled sample cassette 110 is formed by cassette labeler 112 configured to receive and transfer the sample container label information 136 from computer database 140 to labeled sample cassette 110. Cassette mechanical manipulator 114 is configured to convert labeled sample cassette 110 to an open cassette position 120, to receive the transfer of biopsy sample 108 from labeled sample container 106 through filter 122 into open cassette position 120. A camera (not shown) can capture photographs and video of the labeled sample container and the cassette to ensure that the biopsy tissue sample is transferred from the labeled sample container to the cassette. The camera can capture this data before, during, or after transfer of the biopsy sample from the labeled sample cassette to an open cassette. Further, the photographs and videos can be sent to the CPU 138 and computer database 140 to analyze the size, color, and number of particles in the biopsy tissue specimen.

The cassette mechanical manipulator is configured to return the open cassette position 120 to closed cassette position 124 after transfer of biopsy sample 108 to form a filled sample cassette 126. Formalin repository 128 is configured to receive filled sample cassette 126. Sample container lid removal mechanism 116 is configured to remove lid 118 from labeled sample container 106 before transfer of biopsy sample 108 to labeled sample cassette 110 in open cassette position 120. Container mechanical manipulator 102 is configured to position labeled sample container 106 under sample container rinsing mechanism 130 before, during, or after transfer of biopsy sample 108 to labeled sample cassette 110 in open cassette position 120. Sample container rinsing mechanism 130 is configured to transfer labeled sample container 106 to sample container disposal repository 132 after rinsing. Scanning optical reader 134 is configured to read label information 136 from labeled sample container 106 and to transfer label information 136 to central processing unit (CPU) 138 and computer database 140.

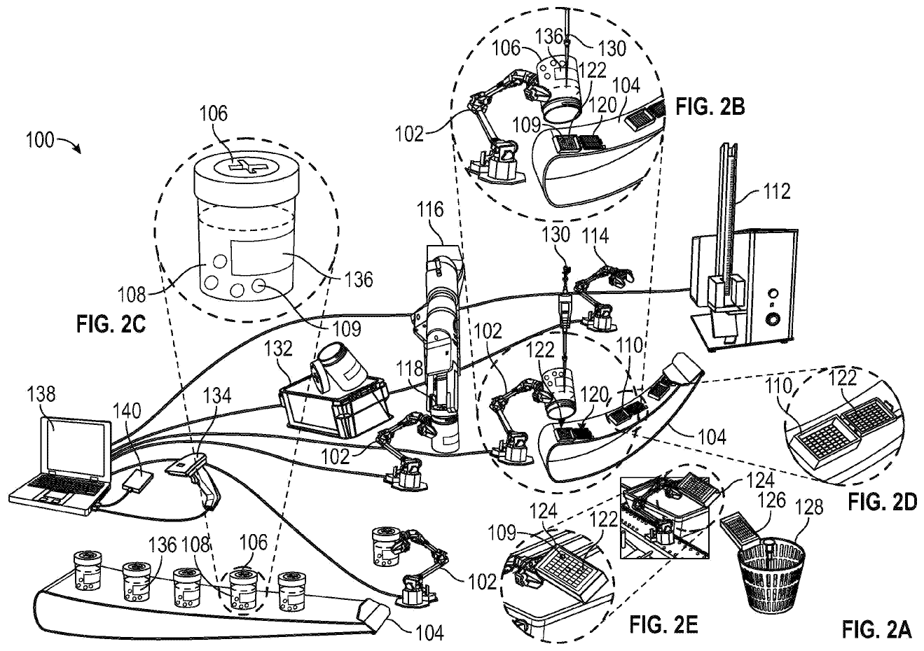

In an embodiment of an automated system disclosed herein, referring to FIG. 2, automated system 100 includes container mechanical manipulator 102 and ramp sample conveyor 104 configured to convey labeled sample container 106 containing biopsy sample 108, including at least one biopsy tissue specimen 109, to container mechanical manipulator 102. Labeled sample cassette 110 is formed by cassette labeler 112 configured to receive and transfer the sample container label information 136 from computer database 140 to labeled sample cassette 110. Cassette mechanical manipulator 114 is configured to convert labeled sample cassette 110 to an open cassette position 120, to receive the transfer of biopsy sample 108 from labeled sample container 106 through filter 122 into open cassette position 120, and to return open cassette position 120 to closed cassette position 124 after transfer of biopsy sample 108 to form filled sample cassette 126. Formalin repository 128 is configured to receive filled sample cassette 126. Sample container lid removal mechanism 116 is configured to remove lid 118 from labeled sample container 106 before transfer of biopsy sample 108 to labeled sample cassette 110 in open cassette position 120. Container mechanical manipulator 102 is configured to position labeled sample container 106 under sample container rinsing mechanism 130 before, during, or after transfer of biopsy sample 108 to labeled sample cassette 110 in open cassette position 120. Sample container rinsing mechanism 130 is configured to transfer labeled sample container 106 to sample container disposal repository 132 after rinsing. Scanning optical reader 134 is configured to read label information 136 from labeled sample container 106 and to transfer label information 136 to central processing unit (CPU) 138 and computer database 140, so that the data from the label can be associated or correlated with the data from the biopsy tissue sample, wherein the data from the biopsy tissue sample includes the size, color, and number of particles of the biopsy tissue sample.

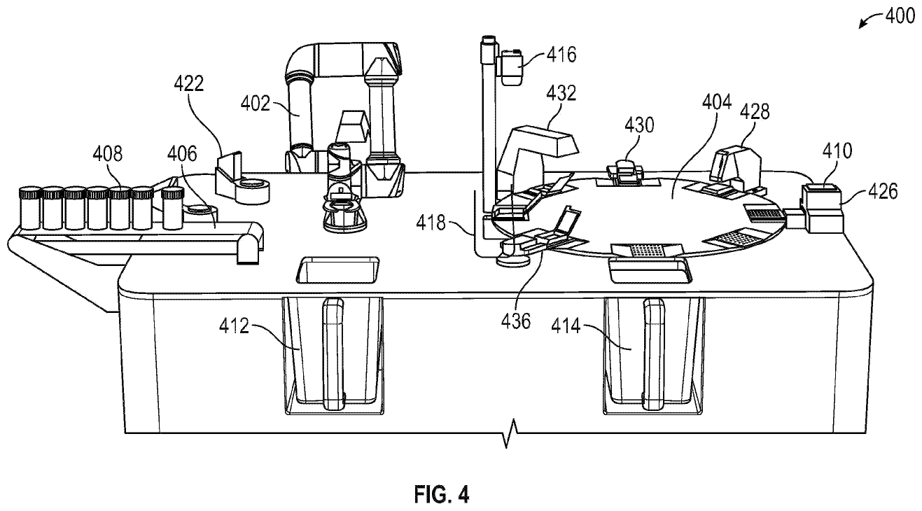

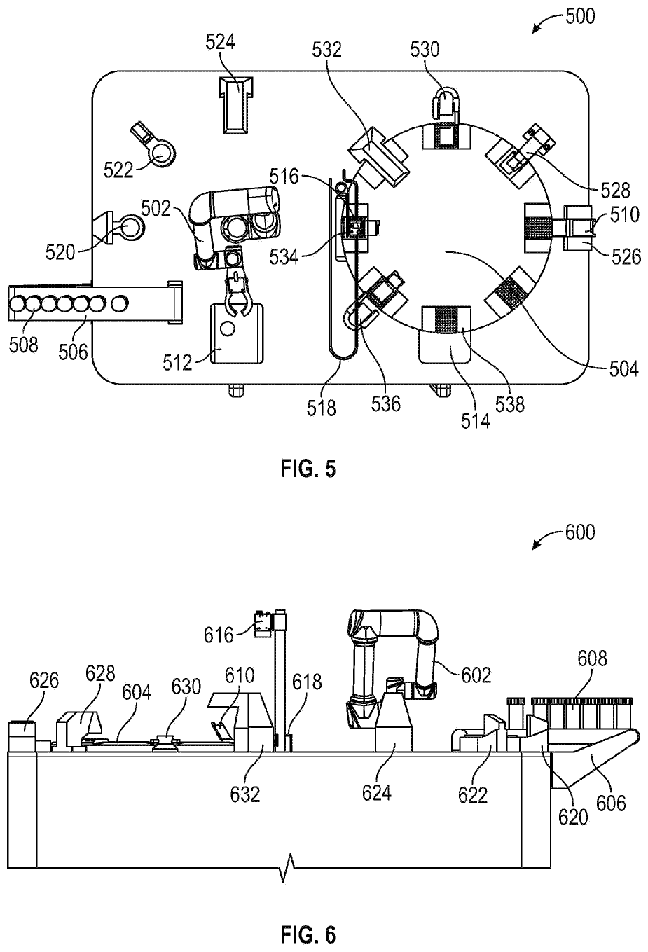

Further embodiments of automated systems for processing a biopsy sample are disclosed herein. In an embodiment, referring to left side of FIGS. 4, 5, and 6, a labeled sample container 408, 508, 608 is positioned on a conveyor belt 406, 506, 606, wherein the labeled sample container contains a biopsy sample or biopsy tissue specimen (not shown). A robotic arm 402, 502, 602 moves the labeled sample container or vial to a vial scanner 520, 620, wherein the vial scanner has a rotary plate, where the vial can be rotated by the rotary plate and the label of the sample container can be scanned, uploading data from the label to a CPU and/or database (not shown). Once scanning is complete, the labeled sample container is moved by the robotic arm to a vial printer and/or vial scanner 422, 522, 622, having a rotary plate, where the labeled sample container has second label printed onto the sample container. Once the second label is printed onto the sample container, the robotic arm positions the sample container under a vial lid remover 524, 624, where the lid of the sample container is removed. Once the lid is removed, the robotic arm moves the sample container to a sample transfer station 534. At the transfer station, the open vial is scanned and photographed by the high-resolution camera 416, 516, 616, documenting the contents of the open vial before the transfer step. Then, the robotic arm positions the opening of the sample container facing downward over an open cassette to dump the contents of the sample vial onto the open cassette for a first filtration step. Then, the fluid lines 418, 518, 618 spray into the opening of the sample vial and the residual contents of the vial, if any, are dumped onto the open cassette for a second filtration step. Then, the open vial is scanned and photographed again by the high-resolution camera to ensure that all of contents of the vial were transferred to the open cassette. If not, then the rinse, dump, and filtration steps can be repeated as necessary. After transferring the biopsy sample, the robotic arm transfer or drops the sample vial into a vial bin 412, 512.

In an embodiment, referring to the right side of FIGS. 4, 5, and 6, the automated system 400, 500, 600 includes a sample cassette 410, 510, 610. The sample cassette is dispensed by a cassette dispenser 426, 526, 626 onto a rotary table 404, 504, 604. The rotary table rotates to position the sample cassette beneath a cassette labeler 428, 528, 628, where the cassette labeler labels the sample cassette. Once labeling is complete, the rotary table rotates the sample cassette to a cassette lid lifting mechanism 430, 530, 630, where the lid of the sample cassette is opened. Once the cassette opening step is completed, the rotary table positions the open sample cassette beneath a cassette scanner 432, 532, 632, where the cassette scanner scans the open cassette to verify and document that no foreign objects are already present in the cassette. Once the scanning is complete, the rotary table rotates the sample cassette to a sample transfer station, where the cassettes is positioned over a drain (not shown) and under the high-resolution camera 416, 516, 616. Once the cassette is in position, the robotic arm holds the sample container with the opening facing downward over an open cassette to dump the contents of the sample vial onto the open cassette for a first filtration step. Then, the fluid lines 418, 518, 618 spray into the opening of the sample vial and the residual contents of the vial, if any, are dumped onto the open cassette for a second filtration step. Then, the open vial is scanned and photographed again by the high-resolution camera to ensure that all of contents of the vial were transferred to the open cassette. If not, then the rinse, dump, and filtration steps can be repeated as necessary. Once transfer is complete, the high-resolution camera scans, photographs, and documents the color, size and number of the biopsy samples present in the open cassette. Once the biopsy sample has been documented by the high-resolution camera, then the rotary table rotates the open cassette to a cassette lid closing mechanism 436, 536, where the lid of the open cassette is closed forming a closed cassette with the biopsy sample inside the cassette. Once the closed cassette is formed, the rotary table rotates the closed cassette to a cassette transfer station 438, 538, wherein the cassette is transferred (dropped) into a cassette bin 414, 514, wherein the cassette bin is a formalin repository.

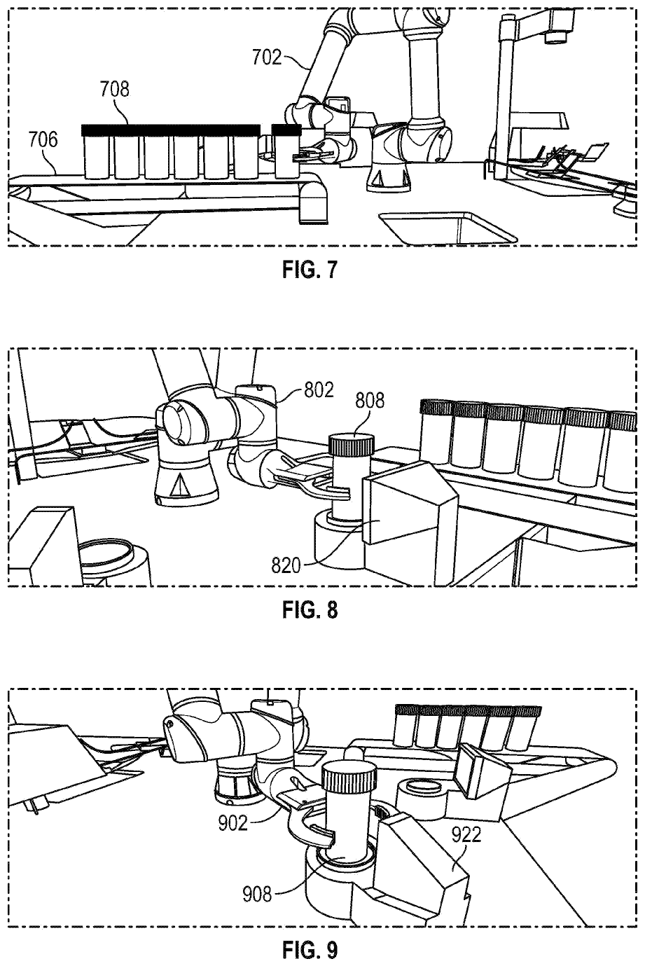

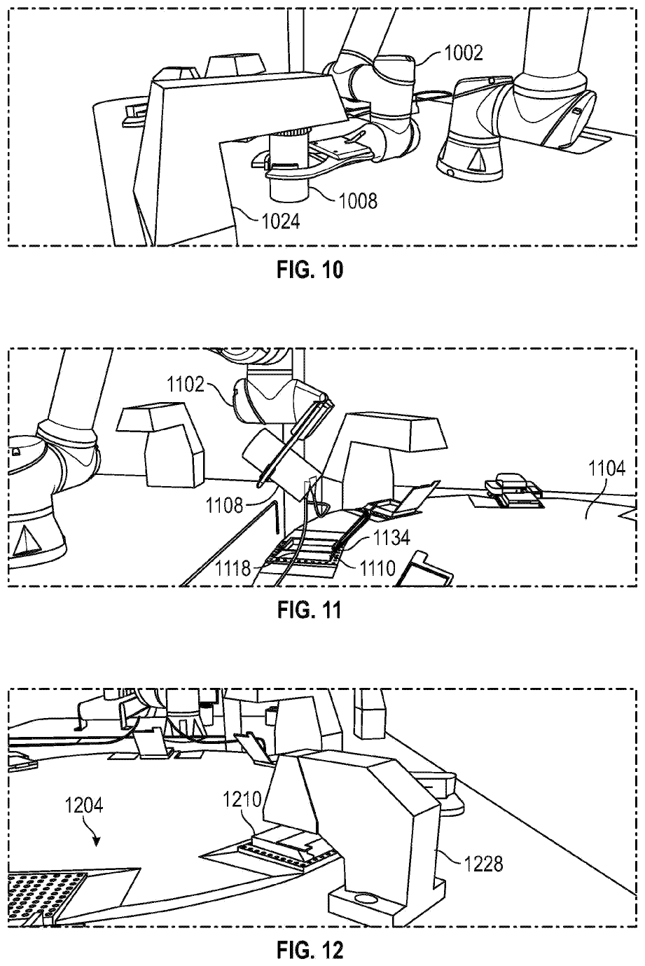

FIGS. 7-16 provide closeup depictions of the steps discussed above for FIGS. 4-6. In FIG. 7, the robotic arm 702 picks up or removes the labeled sample container or sample vial 708 from the conveyor belt 706. In an FIG. 8, the robotic arm 802 moves the labeled sample container 808 to a vial scanner 820, wherein the vial scanner has a rotary plate, where the vial can be rotated by the rotary plate and the label of the sample container can be scanned, uploading data from the label to a CPU and/or database (not shown). In FIG. 9, once scanning is complete, the labeled sample container 908 is moved by the robotic arm 902 to a vial printer 922, having a rotary plate, where the labeled sample container has a second label printed onto the sample container. In FIG. 10, once the second label is printed onto the sample container, the robotic arm 1002 positions the sample container 1008 under a vial lid remover 1024, where the lid of the sample container is removed. Referring to FIG. 11, once the lid is removed, the robotic arm moves the sample container to a sample transfer station 1134. At the transfer station, the open vial is scanned and photographed by the high-resolution camera (not shown), documenting the contents of the open vial before the transfer step. Then, the robotic arm 1102 positions the opening of the sample container 1108 facing downward over an open cassette 1110 located on the rotary table 1104 to dump the contents of the sample vial onto the open cassette for a first filtration step. Then, the fluid lines 1118 spray into the opening of the sample vial and the residual contents of the vial, if any, are poured or dumped onto the open cassette for a second filtration step. Then, the open vial is scanned and photographed again by the high-resolution camera to ensure that all of contents of the vial were transferred to the open cassette.

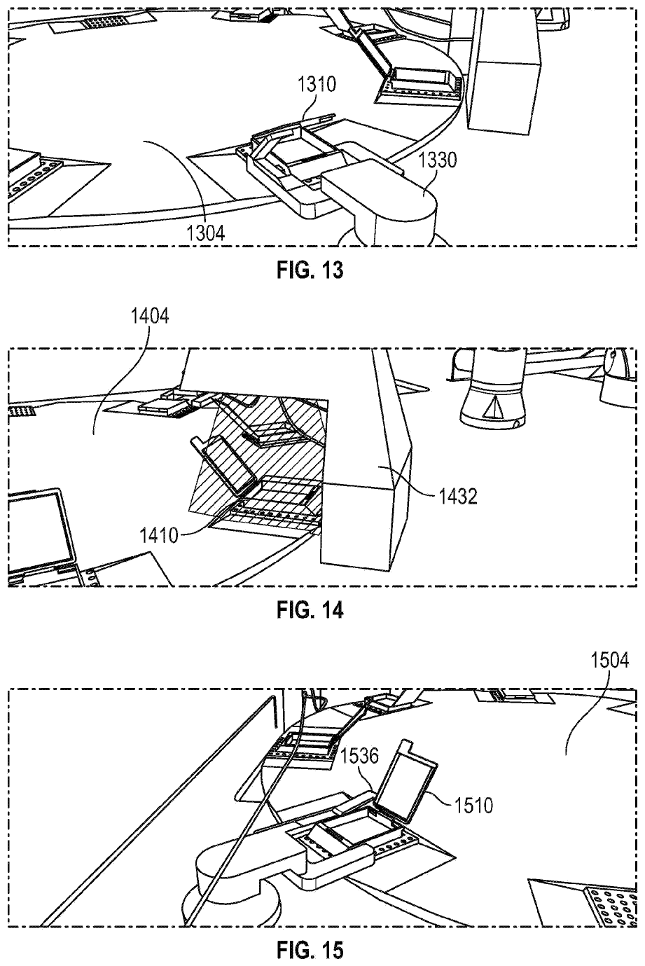

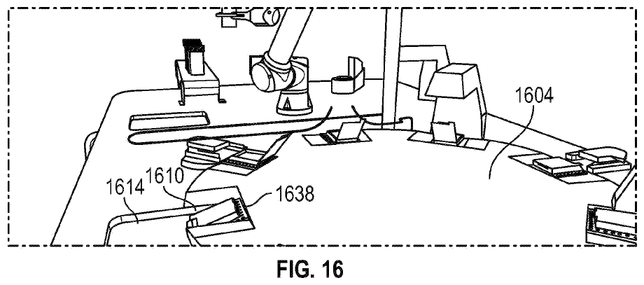

In FIG. 12, the rotary table 1204 rotates to position the sample cassette 1210 beneath a cassette labeler 1228, where the cassette labels the sample cassette. In FIG. 13, once labeling is complete, the rotary table 1304 rotates the sample cassette 1310 to a cassette lid lifting mechanism 1430, where the lid of the sample cassette is opened. In FIG. 14, once the cassette opening step is completed, the rotary table 1404 positions the open sample cassette 1410 beneath a cassette scanner 1432, where the cassette scanner scans the contents of the cassette to document and ensure that no foreign contaminants are present in the open cassette. Referring back to FIG. 11, once the scanning is complete, the rotary table 1104 rotates the sample cassette 1110 to a sample transfer station 1134, where the cassettes is positioned over a drain (not shown) and under the high-resolution camera. Once the cassette is in position, the robotic arm 1102 holds the sample container 1108 with the opening facing downward over the open cassette to dump the contents of the sample vial onto the open cassette for a first filtration step. Then, the fluid lines 1118 spray into the opening of the sample vial and the residual contents of the vial, if any, are dumped onto the open cassette for a second filtration step. Then, the open vial is scanned and photographed again by the high-resolution camera to ensure that all of contents of the vial were transferred to the open cassette. If not, then the rinse, dump, and filtration steps can be repeated as necessary. Once transfer is complete, the high-resolution camera scans, photographs, and documents the color, the size and number of the biopsy samples present in the open cassette. In FIG. 15, once the biopsy sample has been (successfully) transferred to the open sample cassette and documented by the high-resolution camera, then the rotary table 1504 rotates the open cassette sample 1510 to a cassette lid closing mechanism 1536, where the lid of the open cassette is closed forming a closed sample cassette with the biopsy sample inside the cassette. In FIG. 16, once the closed cassette is formed, the rotary table 1604 rotates the closed cassette 1610 to a cassette transfer station 1638, where the cassette is transferred (dropped) into a cassette bin 1614, wherein the cassette bin is a formalin repository.

### Sample Containers, Sample Cassettes, and Biopsy Samples of Various Embodiments

Embodiments of automated systems for processing a biopsy sample disclosed herein include biopsy sample containers. Sample containers of various embodiments can include such containers or bottles that are routinely used in the processing of biopsy samples. Such containers can be formed from a plastic or a glass material and can include a lid that in certain embodiments can include a snap-on lid or a screw-on lid, so long as the biopsy sample containers are sealable. Such containers are of a sufficient size to contain a standard biopsy sample. Sample containers in various embodiments can include label information. In various embodiments, the sample container label information includes a patient name, a patient date of birth, a sample record number, a sample collection date, a sample collection location, a sample bar code, a sample quick response code (QR code), or a combination thereof.

Embodiments of automated systems herein include a sample cassette. Sample cassettes of various embodiments can include such cassettes that are routinely used in the processing of biopsy samples. Such cassettes can be formed from a plastic material, and can include a filter for the transfer of a biopsy sample from the sample container to the sample cassette by filtration. In certain embodiments, the filter includes a mesh material. In certain embodiments, the mesh material is built into the structure of the cassette. In certain embodiments, the mesh material includes a mesh bag. In such embodiments, the mesh bag can be used to transfer a biopsy sample to the mesh bag, after which the mesh bag is closed and inserted into a sample cassette. In certain embodiments, the sample cassette includes cassette label information that corresponds to, or is identical to, the sample container label information on the corresponding sample container. In certain embodiments, the cassette label information includes a unique alphanumeric sequence, a cassette bar code, or a cassette QR code.

Embodiments of automated systems herein include a biopsy sample. Biopsy samples of various embodiments can include such biopsy samples as are routinely processed for analysis by a pathologist, a doctor, or another medical professional. In certain embodiments, the biopsy sample includes at least one biopsy tissue specimen, and in some embodiments includes a volume of formalin. In certain embodiments, the at least one biopsy tissue specimen has a diameter of from about 0.5 mm to about 5 mm. In certain embodiments, the at least one biopsy tissue specimen has a diameter of from about 1 mm to about 4 mm. In certain embodiments, the at least one biopsy tissue specimen has a diameter of from about 2 mm to about 3 mm. In certain embodiments, the volume of formalin includes about 10% formaldehyde and about 90% water, and has a volume of from about 10 ml to about 15 ml. In certain embodiments, the volume of formalin has a volume of from about 11 ml to about 14 ml. In certain embodiments, the volume of formalin has a volume of from about 12 ml to about 13 ml.

### Sample Conveyors of Various Embodiments

Embodiments of automated systems herein include a sample conveyor. In some embodiments, a sample conveyor is configured to convey one or more labeled sample containers containing a biopsy sample to a container mechanical manipulator. In some embodiments, the sample conveyor is configured to convey one or more filled sample cassettes from the cassette mechanical manipulator to a formalin repository. In such embodiments, the sample conveyor can include one or more conveyor belts; in such embodiments, one or more sample containers can be placed on a conveyor belt to be conveyed to the container mechanical manipulator for further processing,

In certain embodiments, the automated system includes a cassette conveyor. In such embodiments, the cassette conveyor is configured to convey one or more sample cassettes or empty labelled cassettes from a cassette labeler to a cassette mechanical manipulator or to a container mechanical manipulator for further processing. In certain embodiments, the cassette conveyor includes a conveyor belt. In such embodiments, one or more cassettes can be conveyed on a conveyor belt from the cassette labeler to the cassette mechanical manipulator or the container mechanical manipulator, or one or more filled cassettes can be conveyed from the cassette mechanical manipulator to the formalin repository.

In certain embodiments, the sample conveyor or the cassette conveyor includes a ramp or a slide. In such embodiments, one or more sample containers can be placed on the ramp or slide to convey the sample containers to a container mechanical manipulator, or one or more cassettes can be placed on the ramp or slide to be conveyed to the cassette mechanical manipulator, or one or more filled cassettes can be conveyed from the cassette mechanical manipulator to the formalin repository. The conveyor belt, ramp or slide in various embodiments can include a smooth surface or an angled surface, to allow the sample containers or cassettes to be conveyed by gravity or along a surface with low friction to allow for a smoother or more efficient conveying action. In some embodiments, the ramp or slide can include a tapered shape that is narrowed at a distal end, in order to control the delivery of one sample container or cassette at a time to the appropriate mechanical manipulator. In some embodiments, the conveyor belt, ramp or slide can include one or more areas having a shape and size configured to hold one or more sample containers or cassettes in a stable position, such as a slot or holder, for delivery to the appropriate mechanical manipulator. In some embodiments, the conveyor belt, ramp, or slide can include a rubber surface, a rough surface, or other surface configured to control the motion of the sample containers or cassettes by friction. In certain embodiments, the one or more conveyor belts, ramps or slides can be motorized. Embodiments of a sample conveyor herein can have a benefit of allowing a large number of sample containers or cassettes to be delivered to the container mechanical manipulator the cassette mechanical manipulator, or the formalin repository, respectively, thus increasing the efficiency of biopsy sample processing. Such embodiments can also have a benefit of providing for an orderly stepwise processing of each sample container and corresponding sample cassette, thus providing for accuracy in biopsy sample processing.

### Container Mechanical Manipulators of Various Embodiments

Embodiments of an automated system for processing a biopsy sample herein include a container mechanical manipulator. The container mechanical manipulator in various embodiments is configured to transfer a biopsy sample from a labeled sample container to an empty sample cassette. In certain embodiments, the container mechanical manipulator includes a robotic arm. In certain embodiments, the robotic arm includes a clamp mechanism that is configured to hold or grip a sample container in a controlled or fixed position. In such embodiments, the robotic arm can move sample containers through biopsy sample processing steps; for example, the robotic arm clamp mechanism can hold or grip a sample container to move it from the sample conveyor into position for lid removal by a sample container lid removal mechanism, into position for transfer of a biopsy sample into a sample cassette, into position for rinsing by a sample container rinsing mechanism, or into position for disposal into a sample container disposal repository. In certain embodiments, the robotic arm is configured to transfer a biopsy sample into a filter including a mesh bag. In certain embodiments, the robotic arm is configured to transfer a mesh bag containing a biopsy sample into an open sample cassette. In certain embodiments, the robotic arm is capable of at least one of translational motion and at least one rotational motion. In such embodiments, the robotic arm can be configured to be capable of a range of motions to allow the robotic arm to carry out the required biopsy sample processing steps. In certain embodiments, the container mechanical manipulator and the cassette mechanical manipulator can include the same mechanical manipulator; in other embodiments, they include different mechanical manipulators. Embodiments of a container mechanical manipulator herein can have a benefit of more efficient biopsy sample processing for steps requiring the mechanical manipulation of sample containers. For such embodiments, the container mechanical manipulator can perform the mechanical manipulation more efficiently than a technician can perform the same steps manually. Such embodiments can also have a benefit of decreasing costs associated with manual performance of sample container manipulation, as well as increasing safety for personnel, by eliminating or decreasing the need to handle volumes of formaldehyde-containing solutions.

### Sample Container Lid Removal Mechanisms of Various Embodiments

Embodiments of an automated system for processing a biopsy sample herein include a sample container lid removal mechanism. In various embodiments, the sample container lid removal mechanism is configured to remove a lid from a sample container, before the biopsy sample is transferred to an empty sample cassette. Such a lid removal mechanism may include a mechanical or a motorized lid removal mechanism. In certain embodiments, the sample container mechanical manipulator includes the sample container lid removal mechanism. In other embodiments, the sample container mechanical manipulator is configured to position the sample container for lid removal by the lid removal mechanism. In some embodiments, the sample container lid removal mechanism includes a lid mechanical manipulator. In certain embodiments, the sample container lid includes a screw-on lid or a snap-on lid. In various embodiments, the lid removal mechanism can be configured to be capable of a range of motions in order to remove a lid from a biopsy sample container. Embodiments of a sample container lid removal mechanism can have benefits of efficiency in processing the lid removal from many biopsy sample containers in considerably less time that would be required for manual lid removal. Such embodiments can also have a benefit of decreasing costs, as well as increasing safety for personnel by eliminating or decreasing the need to handle volumes of formaldehyde-containing solutions.

### Sample Container Rinsing Mechanisms of Various Embodiments

Embodiments of an automated system for processing a biopsy sample herein include a sample container rinsing mechanism. In various embodiments, the sample container mechanical manipulator is configured to position at least one of a labeled sample container, an empty sample cassette, and a filled sample cassette under the sample container rinsing mechanism either before, during, or after transfer of the biopsy sample to the empty sample cassette. Certain embodiments also include a sample container disposal repository. In certain embodiments, the sample container rinsing mechanism includes a storage mechanical manipulator configured to transfer the sample container to the sample container disposal repository, after rinsing the sample container with a volume of a rinsing solution. In such embodiments, the rinsing solution includes water, formaldehyde, formalin, or a combination thereof. In certain embodiments, the storage mechanical manipulator and the cassette mechanical manipulator include the same mechanical manipulator; in other embodiments, they are different mechanical manipulators. In certain embodiments, the automated system includes a fluid waste disposal mechanism that is configured to receive the residual formalin volume after transfer of a biopsy sample to a sample cassette, or to receive the residual volume of rinsing solution after rinsing of a sample container, or both. Embodiments of a sample container rinsing mechanism herein can have benefits of increasing the efficiency of sample container rinsing and disposal, as well as reducing costs and safety hazards associated with manual processing.

### Cassette Mechanical Manipulators of Various Embodiments

Embodiments of an automated system for processing a biopsy sample herein include a cassette mechanical manipulator. The cassette mechanical manipulator in various embodiments is configured to convert an empty sample cassette from a closed to an open cassette position, to receive a transfer of a biopsy sample from a sample container by filtration, and to return the sample cassette to a closed cassette position after transfer of the biopsy sample to form a filled sample cassette. In certain embodiments, the cassette mechanical manipulator is configured to move an empty sample cassette in an open cassette position in place for transfer of a biopsy sample from a sample container moved into position by the container mechanical manipulator. In certain embodiments, the cassette mechanical manipulator is configured to place one or more filled sample cassettes to a formalin repository. In such embodiments, the formalin repository contains a volume of formalin solution and is configured to receive one or more filled sample cassettes. In certain embodiments, the cassette mechanical manipulator is configured to place one or more filled sample cassettes on a sample conveyor to be conveyed to a formalin repository.

In certain embodiments, the cassette mechanical manipulator includes a robotic arm. In certain embodiments, the cassette mechanical manipulator includes a rotary table, having multiple sample stations, wherein the sample stations have a drain beneath them and a mechanism for transferring a cassette into the cassette bin, such as an actuator configured to push or slide the cassette off of the rotary table and into the cassette bin. In certain embodiments, the robotic arm includes a clamp mechanism that is configured to hold or grip a sample cassette in a controlled or fixed position. In such embodiments, the robotic arm can move sample cassettes through biopsy sample processing steps; for example, the robotic arm clamp mechanism can hold or grip an empty sample cassette to convert it from a closed to an open cassette position, to receive the transfer of the biopsy sample from the sample container, and to return the sample cassette to the closed cassette position after transfer of the biopsy sample to form a filled sample cassette. In certain embodiments, the robotic arm is capable of at least one of translational motion and at least one rotational motion. In such embodiments, the robotic arm can be configured to be capable of a range of motions to allow the robotic arm to carry out the required biopsy sample processing steps. Embodiments of a cassette mechanical manipulator herein can have a benefit of more efficient biopsy sample processing for steps requiring the mechanical manipulation of sample cassettes. For such embodiments, the cassette mechanical manipulator can perform the mechanical manipulation more efficiently than a technician can perform the same steps manually. Such embodiments can also have a benefit of decreasing costs associated with manual performance of sample cassette manipulation, as well as increasing safety for personnel, by eliminating or decreasing the need to handle volumes of formaldehyde-containing solutions.

### Cassette Labelers of Various Embodiments

Embodiments of an automated system for processing a biopsy sample herein include a cassette labeler. In various embodiments, the cassette labeler is configured to receive sample container label information from a computer database, and to label an empty sample cassette with cassette label information to form an empty labeled sample cassette. In certain embodiments, the cassette labeler is configured to label a filled sample cassette containing a biopsy sample, to form a filled labeled sample cassette. In such embodiments, the cassette labeler labels a sample cassette with cassette label information that corresponds to the label information from the sample container being processed. In such embodiments, the correct label information is transferred from the sample container to the corresponding sample cassette. In certain embodiments, the cassette labeler is configured to deliver labeled empty sample cassettes to a cassette conveyor for processing by the cassette mechanical manipulator. Embodiments of a cassette labeler herein can provide benefits of greater accuracy and efficiency in labeling of cassettes compared to manual processing.

### Scanning Optical Readers and Scanning Mechanisms of Various Embodiments

Embodiments of an automated system for processing a biopsy sample herein include a scanning optical reader. In such embodiments, the scanning optical reader is configured to read label information from a labeled sample container, and to transfer the label information to a central processing unit (CPU) and a computer database that is configured to store the label information. In certain embodiments, the stored label information is transferred to a cassette labeler. In certain embodiments, the scanning optical reader is manually operated; in such embodiments, the optical reader can include a hand-held reader device. In other embodiments, the scanning optical reader is configured to operate by an automated mechanism to read the sample container label information. The scanning optical reader in various embodiments can have a wired connection to the CPU and computer database, or have a wireless connection. In certain embodiments, the scanning optical reader includes a bar code reader, a camera, or a portable image capture device, such as a tablet or camera. Such embodiments can have a benefit of reading and storing label information and other information about a biopsy sample, such as sample characteristics, wherein sample characteristics can include the number of biopsy sample particles, the color of the particles, and the size of the particles, in an efficient and cost-effective manner.

In certain embodiments, the automated system includes a pre-scanning mechanism configured to scan the biopsy sample in the sample container to detect a sample error. In such embodiments, the pre-scanning mechanism can be included in the scanning optical reader; in other embodiments, the pre-scanning mechanism can include a separate mechanism. In various embodiments, the pre-scanning mechanism can include a bar code reader, a camera, a portable image capture device, or other imaging device. In certain embodiments, the automated system includes a scanning mechanism to detect a sample error, such as contaminants or foreign objects in a filled or empty sample cassette. In such embodiments, the scanning mechanism can include a bar code reader, a camera, a portable image capture device, or other imaging device. Such embodiments can have a benefit of efficiently scanning for sample characteristics that will preclude effective processing and/or analysis, such as tissue specimen sizes that are too large or too small to fit within the specified ranges. Such embodiments can also have a benefit of efficiently scanning for sample errors at any point during the processing of biopsy samples, thus helping to increase the accuracy of sample processing. In certain embodiments, the automated system includes a scanner configured to scan an open cassette before the sample is added. In certain embodiments, the automated system includes a scanner configured to alert the CPU if a foreign object is present. In certain embodiments, the automated system includes a camera or optical scanner to document the presence or absence of foreign objects in an open cassettes before, during, or after addition of a biopsy sample to the cassette.

In certain embodiments, the automated system includes an alarm that is configured to sound when the pre-scanning mechanism or the scanning mechanism detects a sample error. In some embodiments, the alarm can include an alarm included within the automated system; in other embodiments, the alarm can include a remote alarm, such as an alarm connected to a portable image capture device. In various embodiments, a sample error can include the presence of a foreign object in the biopsy sample, the presence of a biopsy tissue specimen having a diameter larger than about 5 mm in the biopsy sample, a biopsy tissue specimen remaining in the sample container after transfer of the biopsy sample to a sample cassette, or a combination thereof. In certain embodiments, a sample error can include an error in the labeling information between the labeled sample container and the corresponding labeled sample cassette. In certain embodiments, the automated system is configured to halt biopsy sample processing upon detection of a sample error. Such embodiments can have benefits of efficiently scanning for sample errors at any point during the processing of biopsy samples, thus helping to efficiently and accurately process a number of biopsy samples. Such embodiments that halt sample processing upon detection of a sample error can also provide a benefit of allowing correction of a sample error to be made before re-starting the sample processing.

### Digital Camera and Sample Scanning

In various embodiments of the automated system, the system is configured to scan, document, record, and transmit images of the contents of a sample vial, including a biopsy sample, to the CPU. In various embodiments of the automated system, the digital camera can provide images that can be scanned by the CPU to provide qualitative and quantitative data regarding the biopsy sample, including the size, type, and color of particles that are part of the biopsy sample.

In various embodiments of the system and method for using the system,
the robotic arm holds an open sample vial under the digital camera before the sample vial and contents of thereof are transferred to an open cassette, the digital camera records images and/or capture video of the contents of the sample vial,
the digital camera transmits those images to the CPU, where the images are stored, scanned for data, such as the size, type, and color of particles, the data can be analyzed and recorded, and correlated with the label information scanned by the optical reader,
the robotic arm dumps the contents of the sample vial onto an open cassette to filter the contents through the cassette, leaving the solid particles of the biopsy sample in or on the open cassette,
the robotic arm positions the open vial under the digital camera to ensure that all of the particles in the open vial were transferred to the open cassette,
the digital camera records images and/or video of the contents of the sample vial in or on the open cassette.

In various embodiments of the system, the data provided by the system can be further analyzed on the CPU.

### Central Processing Units (CPUs) and Databases of Various Embodiments

Embodiments of an automated system herein include a central processing unit (CPU) and a computer database. In various embodiments, the CPU is configured to receive sample container label information from a scanning optical reader, and to store the label information in the computer database. In certain embodiments, the CPU, the computer database, or a combination thereof are included within the automated system; in some embodiments, the CPU, the computer database, or a combination thereof, is separately connected to the automated system. In certain embodiments, the automated system includes a sample camera connected to the CPU, and configured to generate a photographic image of the labeled sample container, the labeled sample cassette, the biopsy sample, the filled labeled sample cassette, or a combination thereof. In such embodiments, the sample camera is configured to store the photographic image in the computer database. In certain embodiments, the photographic image can include a three-dimensional image of the biopsy sample. Such embodiments can provide benefits of one or more photographic images containing information about a biopsy sample, that can increase the accuracy of biopsy sample processing, as well as enhance the quality of subsequent sample analysis. In some embodiments, the CPU and database can be included in a single computer. In some embodiments, one or more of the CPU, a database, a scanning optical reader, and a measuring optical reader be included in a portable image capture device, a computer tablet, computer laptop, or a mobile electronic device. In some embodiments, one or more of the CPU, a database, a scanning optical reader, and a measuring optical reader can include a wireless transmitter, wireless receiver, or an electronic port for operatively connecting these electronic devices.

### Embodiments of Methods for Automating the Processing of a Biopsy Sample

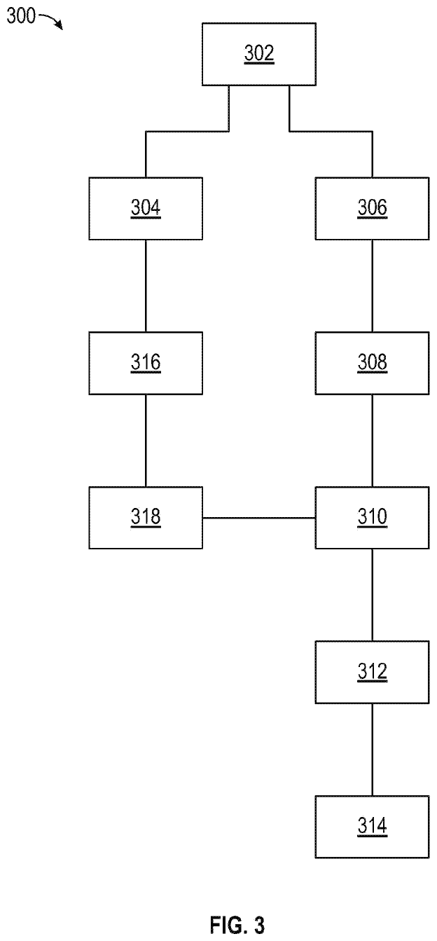

Methods for automating the processing of a biopsy sample are disclosed herein. In an embodiment of such a method, referring to FIG. 3, method 300 includes: providing a labeled sample container 302, wherein the labeled sample container includes a lid and a vessel, wherein the labeled sample container is sealed, and wherein the labeled sample container contains a biopsy sample in a volume of formalin; transmitting sample container label information from the labeled sample container to a CPU and a computer database 304, by scanning the labeled sample container with a scanning optical reader; fixing a position of the labeled sample container 306, by gripping an exterior of the vessel with a container mechanical manipulator; converting the labeled sample container into an open labeled sample container 308, by clamping the lid with a sample container lid removal mechanism and rotating the lid in a clockwise or counterclockwise direction, and/or applying force to the lid in a direction away from the vessel; forming a filled open sample cassette 310, by rotating the container mechanical manipulator until the biopsy sample pours or falls onto a top surface of an open sample cassette; converting the filled open sample cassette into a filled closed sample cassette 312, by applying pressure to an exterior of the filled open sample cassette with a cassette mechanical manipulator; placing the filled closed sample cassette into a formalin repository containing a volume of formalin solution 314; transmitting a cassette label information from the CPU and the computer database to the cassette labeler 316; and labeling the open sample cassette 318, by conveying the open sample cassette to a cassette labeler.

Methods for automating the processing of a biopsy sample are disclosed herein. In various embodiments, the method includes: providing a labeled sample container, wherein the labeled sample container comprises a lid and a vessel, wherein the labeled sample container is sealed, and wherein the labeled sample container contains a biopsy sample in a volume of formalin. In various embodiments, the method includes transmitting sample container label information from the labeled sample container to a CPU and a computer database by scanning the labeled sample container with a scanning optical reader. In various embodiments, the method includes fixing a position of the labeled sample container by gripping an exterior of the vessel with a container mechanical manipulator. In various embodiments, the method includes converting the labeled sample container into an open labeled sample container by clamping the lid with a sample container lid removal mechanism and rotating the lid in a clockwise or counterclockwise direction and/or applying force to the lid in a direction away from the vessel. In various embodiments, the method includes forming a filled open sample cassette by rotating the container mechanical manipulator until the biopsy sample pours or falls onto a top surface of an open sample cassette. In various embodiments, the method includes converting the filled open sample cassette into a filled closed sample cassette by applying pressure to an exterior of the filled open sample cassette with a cassette mechanical manipulator. Certain embodiments include transferring the biopsy sample from the sample container by filtration into the open sample cassette. Certain embodiments include disposing of the volume of formalin after transfer of the biopsy sample to the sample cassette with a fluid disposal mechanism. Certain embodiments further include placing the filled closed sample cassette into a formalin repository containing a volume of formalin solution.

Embodiments of automating biopsy sample processing herein can provide a benefit of automating one or more steps required in the processing of biopsy specimens, thus reducing the time and repetitive manual actions required by the current processes. Such embodiments can also provide an advantage of a versatile modular approach to automating the processing of a biopsy sample, in that various embodiments of an automated system, such as mechanical manipulators and conveyors, can be chosen and incorporated into an automated system as desired in order to automate one or more biopsy sample processing steps. Such embodiments can also provide a benefit of reducing or eliminating the requirement to handle hazardous formalin or formaldehyde containing solutions, thus increasing personnel safety. Such embodiments can provide an additional benefit of reducing costs associated with the current biopsy processing methods. Such embodiments can provide a benefit of an ability to efficiently and accurately process large numbers of biopsy samples in a relatively short period of time, while meeting applicable industry and government regulations for the processing of biopsy samples.

In certain embodiments, the method further includes labeling the open sample cassette by conveying the open sample cassette to a cassette labeler. In certain embodiments, the method further includes labeling a closed sample cassette by conveying the closed sample cassette to a cassette labeler. Embodiments of labeling sample cassettes herein can provide benefits of greater accuracy and efficiency in labeling of cassettes compared to manual processing.

In certain embodiments, the method further includes transmitting a cassette label information from the CPU and the computer database to the cassette labeler. Certain embodiments include printing a unique alphanumeric sequence, a cassette bar code, or a cassette QR code onto a cassette label, wherein the unique alphanumeric sequence, the cassette bar code, or the cassette QR code correspond to the sample container label information. In certain embodiments, the method further includes creating a photographic image of at least one of the labeled sample container or the filled closed sample cassette. In certain embodiments, the method further includes saving the photographic image to the CPU and the computer database. Such embodiments can provide benefits of creating one or more photographic images containing information about a biopsy sample, that can increase the accuracy of biopsy sample processing, as well as enhance the quality of subsequent sample analysis.

In certain embodiments, the method further includes washing the biopsy sample on the open sample cassette, the open labeled sample container, or both with a washing volume from a sample container rinsing mechanism. In various embodiments, the washing volume includes water, formaldehyde, formalin, or a combination thereof. Embodiments of washing a biopsy sample herein can have benefits of increasing the efficiency of sample washing, as well as reducing costs and safety hazards associated with manual processing.

In certain embodiments, the method for automating the processing of a biopsy sample further includes: before, during, or after the step of transmitting sample container label information from the labeled sample container to a CPU and a computer database, determining at least one characteristic of the biopsy sample by imaging the biopsy sample through a transparent wall of the labeled sample container, through a transparent wall of the open labeled sample container, or through an opening of the open labeled sample container with a measuring optical reader, wherein the at least one characteristic of the biopsy sample includes at least one of a color of a biopsy tissue, a number of pieces of the biopsy sample, and a size of the pieces of the biopsy sample; and recording the at least one characteristic in the computer database. In certain embodiments, the scanning optical reader and the measuring optical reader are the same or different. Such embodiments including imaging the biopsy sample can provide benefits of one or more photographic images that contain various useful information about a biopsy sample at various steps within biopsy sample processing. In certain embodiments, one or more recorded characteristics of a particular biopsy sample can be correlated with the sample container label information corresponding to the sample. Such embodiments can provide benefits of increasing the accuracy of biopsy sample processing, as well as enhancing the accuracy and quality of subsequent sample analysis.

### Further Embodiments

Embodiment 1. An automated system for processing a biopsy sample comprising:
a container mechanical manipulator configured to transfer a biopsy sample from a labeled sample container to an empty sample cassette;
a sample container lid removal mechanism configured to remove a lid from the sample container before transfer of the biopsy sample to the empty sample cassette;
a cassette mechanical manipulator configured to convert the empty sample cassette from a closed to an open cassette position, to receive the transfer of the biopsy sample from the sample container by filtration, and to return the sample cassette to the closed cassette position after transfer of the biopsy sample to form a filled sample cassette;
a scanning optical reader configured to read label information from the labeled sample container and to transfer the sample container label information to a central processing unit (CPU) and a computer database configured to store the label information; and
a formalin repository containing a volume of formalin solution and configured to receive the filled sample cassette.

Embodiment 2. The automated system of embodiment 1 or any other embodiment 2-15, further comprising a cassette labeler, wherein the cassette labeler is configured to receive the sample container label information from the computer database and to label the empty sample cassette with cassette label information to form an empty labeled sample cassette, or to label the filled sample cassette to form a filled labeled sample cassette.

Embodiment 3. The automated system of embodiment 1 or any other embodiment 2-15, further comprising a sample conveyor configured to convey the labeled sample container containing a biopsy sample to the container mechanical manipulator; or

wherein the container mechanical manipulator comprises a clamp mechanism configured to hold or grip the sample container in a controlled or fixed position.

Embodiment 4. The automated system of embodiment 1 or any other embodiment 2-15, wherein the container mechanical manipulator or the cassette mechanical manipulator comprises a robotic arm capable of at least one translational motion and at least one rotational motion; or wherein the sample conveyor comprises at least one of a conveyor belt, a ramp, or a slide.

Embodiment 5. The automated system of embodiment 1 or any other embodiment 2-15, further comprising a sample container rinsing mechanism and a sample container disposal repository, wherein the container mechanical manipulator is configured to position at least one of the labeled sample container, the empty sample cassette, and the filled sample cassette under the sample container rinsing mechanism before, during, or after transfer of the biopsy sample to the empty sample cassette.

Embodiment 6. The automated system of embodiment 5, wherein the sample container rinsing mechanism comprises a storage mechanical manipulator configured to transfer the sample container to the sample container disposal repository after rinsing the sample container with a volume of a rinsing solution, wherein the rinsing solution comprises water, formaldehyde, formalin, or a combination thereof; or
wherein the container mechanical manipulator and the cassette mechanical manipulator are the same or different; or
wherein the cassette mechanical manipulator and the storage mechanical manipulator are the same or different.

Embodiment 7. The automated system of embodiment 1, wherein the scanning optical reader comprises a bar code reader, a camera, or a portable image capture device.

Embodiment 8. The automated system of embodiment 1, wherein the sample cassette comprises a filter, wherein the filter comprises a mesh material; or wherein the biopsy sample comprises at least one biopsy tissue specimen and optionally a volume of formalin.

Embodiment 9. The automated system of embodiment 8, wherein the mesh material comprises a mesh bag; wherein the at least one biopsy tissue specimen has a diameter of from about 0.5 mm to about 5 mm; or the volume of formalin comprises about 10% formaldehyde and about 90% water, and has a volume of from about 10 ml to about 15 ml.

Embodiment 10. The automated system of embodiment 2 or any other embodiment 2-15, further comprising a cassette conveyor, wherein the cassette conveyor comprises a slide, a ramp, or a conveyor belt; or wherein the cassette conveyor belt is configured to convey empty labeled cassettes from the cassette labeler to at least one of the container mechanical manipulator or the cassette mechanical manipulator.

Embodiment 11. The automated system of embodiment 1 or any other embodiment 2-15, wherein the container mechanical manipulator comprises the sample container lid removal mechanism; or wherein the sample container lid removal mechanism comprises a lid mechanical manipulator; or wherein the sample container lid comprises a screw-on lid or a snap-on lid.

Embodiment 12. The automated system of embodiment 2 or any other embodiment 2-15, wherein the sample container label information comprises a patient name, a patient date of birth, a sample record number, a sample collection date, a sample collection location, a sample bar code, a sample quick response code (QR code), or a combination thereof; or

wherein the cassette label information comprises a unique alphanumeric sequence, a cassette bar code, or a cassette QR code.

Embodiment 13. The automated system of embodiment 1 or any other embodiment 2-15, further comprising a pre-scanning mechanism configured to scan the biopsy sample in the sample container to detect a sample error; or further comprising a scanning mechanism to detect a sample error in the filled sample cassette.

Embodiment 14. The automated system of embodiment 13 or any other embodiment 2-15, further comprising an alarm configured to sound when the pre-scanning mechanism or the scanning mechanism detects a sample error; or wherein the sample error comprises the presence of a foreign object in the biopsy sample, the presence of a biopsy tissue specimen having a diameter larger than about 5 mm in the biopsy sample, a biopsy tissue specimen remaining in the sample container after transfer of the biopsy sample to the sample cassette, or a combination thereof; or wherein the system is configured to halt biopsy sample processing upon detection of a sample error.

Embodiment 15. The automated system of embodiment 1 or any other embodiment 2-15, further comprising a sample camera connected to the CPU, and configured to generate a photographic image of the labeled sample container, the labeled sample cassette, the biopsy sample, the filled labeled sample cassette, or a combination thereof; and to store the photographic image in the computer database.

Embodiment 16. A method for automating the processing of a biopsy sample comprising:
providing a labeled sample container, wherein the labeled sample container comprises a lid and a vessel, wherein the labeled sample container is sealed, and wherein the labeled sample container contains a biopsy sample in a volume of formalin;
transmitting sample container label information from the labeled sample container to a CPU and a computer database by scanning the labeled sample container with a scanning optical reader;
fixing a position of the labeled sample container by gripping an exterior of the vessel with a container mechanical manipulator;
converting the labeled sample container into an open labeled sample container by clamping the lid with a sample container lid removal mechanism and rotating the lid in a clockwise or counterclockwise direction and/or applying force to the lid in a direction away from the vessel;
forming a filled open sample cassette by rotating the container mechanical manipulator until the biopsy sample pours or falls onto a top surface of an open sample cassette; and
converting the filled open sample cassette into a filled closed sample cassette by applying pressure to an exterior of the filled open sample cassette with a cassette mechanical manipulator.

Embodiment 17. The method of embodiment 16 or any other embodiment 17-22, further comprising:
labeling the open sample cassette by conveying the open sample cassette to a cassette labeler; or labeling a closed sample cassette by conveying the closed sample cassette to a cassette labeler.

Embodiment 18. The method of embodiment 16 or any other embodiment 17-22, further comprising placing the filled closed sample cassette into a formalin repository containing a volume of formalin solution.

Embodiment 19. The method of embodiment 17 or any other embodiment 17-22, further comprising transmitting a cassette label information from the CPU and the computer database to the cassette labeler; or

printing a unique alphanumeric sequence, a cassette bar code, or a cassette QR code onto a cassette label, wherein the unique alphanumeric sequence, the cassette bar code, or the cassette QR code correspond to the sample container label information.

Embodiment 20. The method of embodiment 16 or any other embodiment 17-22, further comprising washing the biopsy sample on the open sample cassette, the open labeled sample container, or both with a washing volume comprising water, formaldehyde, formalin, or a combination thereof from a sample container rinsing mechanism.

Embodiment 21. The method of embodiment 16 or any other embodiment 17-22, further comprising creating a photographic image of at least one of the labeled sample container or the filled closed sample cassette; and saving the photographic image to the CPU and the computer database.

Embodiment 22. The method of embodiment 16 or any other embodiment 17-22, further comprising,
before, during, or after the step of transmitting sample container label information from the labeled sample container to a CPU and a computer database,
determining at least one characteristic of the biopsy sample by imaging the biopsy sample through a transparent wall of the labeled sample container, through a transparent wall of the open labeled sample container, or through an opening of the open labeled sample container with a measuring optical reader, or through the open sample cassette,
wherein the at least one characteristic of the biopsy sample includes at least one of a color of a biopsy tissue, a number of pieces of the biopsy sample, and a size of the pieces of the biopsy sample; and
recording the at least one characteristic in the computer database; and optionally, wherein the scanning optical reader and the measuring optical reader are the same or different.

### EXAMPLES

Example 1. An automated system for processing biopsy samples will be constructed having the following modular components:

1. A sample conveyor system including a conveyor belt, for conveying labeled biopsy sample containers received at the laboratory to a container mechanical manipulator.

2. A container mechanical manipulator including a robotic arm having a clamp mechanism to hold the sample containers in a fixed position and to transfer the labeled biopsy sample containers from the sample conveyor belt to the lid removal mechanism.

3. A lid removal mechanism including a lid mechanical manipulator to remove lids from the biopsy sample containers before transfer of the samples to the sample cassettes.

4. A sample container rinsing mechanism to rinse empty sample containers after transfer of the biopsy samples to the sample cassettes, including a storage mechanical manipulator to transfer the rinsed sample containers to a sample container disposal depository. The rinsing mechanism will rinse the sample containers with a volume of a water or formalin rinsing solution.

5. A cassette labeler to label cassettes with label information corresponding to each labeled sample container.

6. A cassette mechanical manipulator robotic arm to (a) receive empty labeled cassettes from the cassette labeler, (b) convert each empty labeled cassette to an open position to receive the transfer of the biopsy sample from the corresponding labeled sample container by filtration through the sample cassette filter, and (c) return the filled sample cassette to a closed position.

7. A cassette conveyor belt for conveying labeled sample cassettes from a cassette labeler to the cassette mechanical manipulator, and to convey filled sample cassettes to a formalin basket. The formalin basket will contain a volume of formalin solution.

8. A scanning optical reader including a bar code reader to read label information from each labeled sample container, and to transfer the sample container label information to a central processing unit (CPU) and a computer database.

9. A CPU and a computer database to store the label information, and to transfer the label information for each sample container to the cassette labeler for the cassette labeler to label a corresponding sample cassette.

10. A sample camera connected to the CPU, for generating a photographic image of each labeled sample container and the biopsy sample, and to store each photographic image in the computer database.

Example 2. A method for automating the processing of a biopsy sample will be carried out including:

1. Provide a labeled sealed sample container that includes a lid and a vessel, the vessel containing a biopsy sample in a volume of formalin.

2. Transmit sample container label information from the labeled sample container to a CPU and a computer database, by scanning the labeled sample container with a scanning optical reader.

3. Fix a position of the labeled sample container by gripping an exterior of the vessel with a container mechanical manipulator.

4. Convert the labeled sample container into an open labeled sample container by clamping the lid with a sample container lid removal mechanism, and rotating the lid in a clockwise or counterclockwise direction and/or applying force to the lid in a direction away from the vessel.

5. Form a filled open sample cassette by rotating the container mechanical manipulator until the biopsy sample pours or falls onto a top surface of an open sample cassette.

6. Convert the filled open sample cassette into a filled closed sample cassette by applying pressure to an exterior of the filled open sample cassette with a cassette mechanical manipulator.

7. Before, during, or after the step of transmitting sample container label information from the labeled sample container to a CPU and a computer database, determine at least one characteristic of the biopsy sample by imaging the biopsy sample directly in the labeled sample container or through a transparent wall of the labeled sample container, through a transparent wall of the open labeled sample container, or through an opening of the open labeled sample container with a measuring optical reader. Optionally, the scanning optical reader and the measuring optical reader are the same or different. Characteristics of the biopsy sample can include at least one of a color of a biopsy tissue, a number of pieces of the biopsy sample, and a size of the pieces of the biopsy sample.

8. Record one or more sample characteristics in the computer database.

What is claimed is:

1. An automated system for processing a biopsy sample comprising:
a container mechanical manipulator configured to transfer a biopsy sample from a labeled sample container to an empty sample cassette;
a sample container lid removal mechanism configured to remove a lid from the sample container before transfer of the biopsy sample to the empty sample cassette;
a cassette mechanical manipulator configured to convert the empty sample cassette from a closed to an open cassette position, to receive the transfer of the biopsy sample from the sample container by filtration, and to return the sample cassette to the closed cassette position after transfer of the biopsy sample to form a filled sample cassette;
a scanning optical reader configured to read label information from the labeled sample container and to transfer the sample container label information to a central processing unit (CPU) and a computer database configured to store the label information; and
a formalin repository containing a volume of formalin solution and configured to receive the filled sample cassette.

2. The automated system of claim 1, further comprising a cassette labeler, wherein the cassette labeler is configured to receive the sample container label information from the computer database and to label the empty sample cassette with cassette label information to form an empty labeled sample cassette, or to label the filled sample cassette to form a filled labeled sample cassette.

3. The automated system of claim 1, further comprising a sample conveyor configured to convey the labeled sample container containing a biopsy sample to the container mechanical manipulator; or
wherein the container mechanical manipulator comprises a clamp mechanism configured to hold or grip the sample container in a controlled or fixed position.

4. The automated system of claim 1, wherein the container mechanical manipulator or the cassette mechanical manipulator comprises a robotic arm capable of at least one translational motion and at least one rotational motion; or
wherein the sample conveyor comprises at least one of a conveyor belt, a ramp, or a slide.

5. The automated system of claim 1, further comprising a sample container rinsing mechanism and a sample container disposal repository, wherein the container mechanical manipulator is configured to position at least one of the labeled sample container, the empty sample cassette, and the filled sample cassette under the sample container rinsing mechanism before, during, or after transfer of the biopsy sample to the empty sample cassette.

6. The automated system of claim 5, wherein the sample container rinsing mechanism comprises a storage mechanical manipulator configured to transfer the sample container to the sample container disposal repository after rinsing the sample container with a volume of a rinsing solution, wherein the rinsing solution comprises water, formaldehyde, formalin, or a combination thereof; or
wherein the container mechanical manipulator and the cassette mechanical manipulator are the same or different; or
wherein the cassette mechanical manipulator and the storage mechanical manipulator are the same or different.

7. The automated system of claim 1, wherein the scanning optical reader comprises a bar code reader, a camera, or a portable image capture device.

8. The automated system of claim 1, wherein the sample cassette comprises a filter, wherein the filter comprises a mesh material; or wherein the biopsy sample comprises at least one biopsy tissue specimen and optionally a volume of formalin.

9. The automated system of claim 8, wherein the mesh material comprises a mesh bag; wherein the at least one biopsy tissue specimen has a diameter of from about 0.5 mm to about 5 mm; or the volume of formalin comprises about 10% formaldehyde and about 90% water, and has a volume of from about 10 ml to about 15 ml.

10. The automated system of claim 2, further comprising a cassette conveyor, wherein the cassette conveyor comprises a slide, a ramp, or a conveyor belt; or wherein the cassette conveyor belt is configured to convey empty labeled cassettes from the cassette labeler to at least one of the container mechanical manipulator or the cassette mechanical manipulator.

11. The automated system of claim 1, wherein the container mechanical manipulator comprises the sample container lid removal mechanism; or wherein the sample container lid removal mechanism comprises a lid mechanical manipulator; or wherein the sample container lid comprises a screw-on lid or a snap-on lid.

12. The automated system of claim 2, wherein the sample container label information comprises a patient name, a patient date of birth, a sample record number, a sample collection date, a sample collection location, a sample bar code, a sample quick response code (QR code), or a combination thereof; or
wherein the cassette label information comprises a unique alphanumeric sequence, a cassette bar code, or a cassette QR code.

13. The automated system of claim 1, further comprising a pre-scanning mechanism configured to scan the biopsy sample in the sample container to detect a sample error; or further comprising a scanning mechanism to detect a sample error in the filled sample cassette.

14. The automated system of claim 13, further comprising an alarm configured to sound when the pre-scanning mechanism or the scanning mechanism detects a sample error; or wherein the sample error comprises the presence of a foreign object in the biopsy sample, the presence of a biopsy tissue specimen having a diameter larger than about 5 mm in the biopsy sample, a biopsy tissue specimen remaining in the sample container after transfer of the biopsy sample to the sample cassette, or a combination thereof; or wherein the system is configured to halt biopsy sample processing upon detection of a sample error.

15. The automated system of claim 1, further comprising a sample camera connected to the CPU, and configured to generate a photographic image of the labeled sample container, the labeled sample cassette, the biopsy sample, the filled labeled sample cassette, or a combination thereof; and to store the photographic image in the computer database.

16. A method for automating the processing of a biopsy sample comprising:
providing a labeled sample container, wherein the labeled sample container comprises a lid and a vessel, wherein the labeled sample container is sealed, and wherein the labeled sample container contains a biopsy sample in a volume of formalin;
transmitting sample container label information from the labeled sample container to a CPU and a computer database by scanning the labeled sample container with a scanning optical reader;
fixing a position of the labeled sample container by gripping an exterior of the vessel with a container mechanical manipulator;
converting the labeled sample container into an open labeled sample container by clamping the lid with a sample container lid removal mechanism and rotating the lid in a clockwise or counterclockwise direction and/or applying force to the lid in a direction away from the vessel;
forming a filled open sample cassette by rotating the container mechanical manipulator until the biopsy sample pours or falls onto a top surface of an open sample cassette; and
converting the filled open sample cassette into a filled closed sample cassette by applying pressure to an exterior of the filled open sample cassette with a cassette mechanical manipulator.

17. The method of claim 16, further comprising:
labeling the open sample cassette by conveying the open sample cassette to a cassette labeler; or labeling a closed sample cassette by conveying the closed sample cassette to a cassette labeler.

18. The method of claim 16, further comprising placing the filled closed sample cassette into a formalin repository containing a volume of formalin solution.

19. The method of claim 17, further comprising transmitting a cassette label information from the CPU and the computer database to the cassette labeler; or
printing a unique alphanumeric sequence, a cassette bar code, or a cassette QR code onto a cassette label, wherein the unique alphanumeric sequence, the cassette bar code, or the cassette QR code correspond to the sample container label information.

20. The method of claim 16, further comprising washing the biopsy sample on the open sample cassette, the open labeled sample container, or both with a washing volume comprising water, formaldehyde, formalin, or a combination thereof from a sample container rinsing mechanism.

21. The method of claim 16, further comprising creating a photographic image of at least one of the labeled sample container or the filled closed sample cassette; and saving the photographic image to the CPU and the computer database.

22. The method of claim 16, further comprising,
before, during, or after the step of transmitting sample container label information from the labeled sample container to a CPU and a computer database,
determining at least one characteristic of the biopsy sample by imaging the biopsy sample through a transparent wall of the labeled sample container, through a transparent wall of the open labeled sample container, or through an opening of the open labeled sample container with a measuring optical reader, or through the open sample cassette,
wherein the at least one characteristic of the biopsy sample includes at least one of a color of a biopsy tissue, a number of pieces of the biopsy sample, and a size of the pieces of the biopsy sample; and
recording the at least one characteristic in the computer database; and optionally, wherein the scanning optical reader and the measuring optical reader are the same or different.
